(19) United States
(12) Patent Application Publication
(10) Pub. No.: US 2025/0302230 A1
(43) Pub. Date: Oct. 2, 2025

(54) TEMPERATURE CONTROL METHOD AND SYSTEM FOR COOKING APPARATUS, COOKING APPARATUS, AND STORAGE MEDIUM

(71) Applicant: JIU TAI GROUP CO., LTD., Hong Kong (CN)

(72) Inventors: Qing WANG, Hong Kong (CN); Lianwei YANG, Hong Kong (CN); Robert NEWTON, Hong Kong (CN)

(21) Appl. No.: 19/186,682

(22) Filed: Apr. 23, 2025

Related U.S. Application Data
(63) Continuation of application No. PCT/CN2022/127472, filed on Oct. 25, 2022.

(51) Int. Cl. A47J 36/32; G06K 7/14; G06V 20/68

(52) U.S. Cl. CPC A47J 36/321; G06K 7/1417; G06V 20/68; A47J 2202/00

(57) ABSTRACT

Provided are a cooking apparatus, a temperature control method and system for a cooking apparatus. The method includes: controlling, based on a quantity and a type of an ingredient in a food region of the cooking apparatus, a heating device of the cooking apparatus to adjust an average temperature of the food region to a first temperature; determining, at a first sampling frequency, a position of the region cold point on a temperature map at each sampling time point, and controlling the heating device to heat the position of the region cold point, to adjust the average temperature of the food region from the first temperature to a second temperature; and collecting a cooking parameter of each ingredient, and controlling, based on the cooking parameter, the heating device to adjust an average temperature of the ingredient from the second temperature to a target temperature.

This application is a continuation of International Patent Application No. PCT/CN2022/127472, filed on Oct. 25, 2022, which is incorporated herein by reference in its entirety.

### FIELD

The present disclosure relates to the field of smart home appliance technologies, and more particularly, to a temperature control method and system for a cooking apparatus, a cooking apparatus, and a storage medium.

### BACKGROUND

Microwave ovens and other common cooking apparatuses used in home kitchens are popular among users due to their high heating efficiency and convenient operations. A conventional microwave oven on the market is made up of a power supply, a magnetron, a rotatable stirrer, a cooking cavity, and other components. The power supply provides a high voltage of a predetermined intensity to the magnetron. The magnetron is excited by the power supply and continuously generates microwaves, which are coupled into the cooking cavity by a waveguide system. Further, the microwaves are refracted in different directions by the rotatable stirrer to allow microwave energy to be evenly distributed in the cooking cavity, thereby enabling heating of the food.

Since cooking parameters such as an optimum cooking temperature, cooking time, and an optimum temperature rise value vary from ingredient to ingredient, a variety of temperature control strategies are set in the present disclosure in a targeted manner by means of collecting a type of each ingredient, a position of the ingredient within the cooking cavity, and an optimum cooking parameter of the ingredient, aiming at meeting a user's need to cook different ingredients simultaneously and get them ready simultaneously with optimum cooking taste.

### SUMMARY

The present disclosure aims to solve at least one of the technical problems in the related art to some extent. To this end, an object of the present disclosure is to provide a temperature control method and system for a cooking apparatus, a cooking apparatus, and a storage medium, which can realize targeted heating of individual ingredients and further, get the individual ingredients ready simultaneously with optimum cooking taste.

In an aspect of the present disclosure, a temperature control method for a cooking apparatus is provided. The temperature control method may include: controlling, based on a quantity and a type of each of at least one ingredient in a food region of the cooking apparatus, a heating device of the cooking apparatus to adjust an average temperature of the food region to a first temperature, in which the first temperature is a temperature at which a region temperature difference between a region cold point and a region hot point of the food region reaches a first temperature difference threshold; determining, at a first sampling frequency, a position of the region cold point on a temperature map at each sampling time point, and controlling the heating device to heat the position of the region cold point, to adjust the average temperature of the food region from the first temperature to a second temperature, in which the temperature map is used to characterize temperature data of respective coordinate points of the cooking apparatus; and collecting a cooking parameter of each of the at least one ingredient, and controlling, based on the cooking parameter, the heating device to adjust an average temperature of the ingredient from the second temperature to a target temperature.

In another aspect of the present disclosure, a temperature control system for a cooking apparatus is further provided. The temperature control system may include a first temperature heating module, a temperature rise heating module, and a target temperature heating module. The first temperature heating module is configured to control, based on a quantity and a type of each of at least one ingredient in a food region of the cooking apparatus, a heating device of the cooking apparatus to adjust an average temperature of the food region to a first temperature, in which the first temperature is a temperature at which a region temperature difference between a region cold point and a region hot point of the food region reaches a first temperature difference threshold. The temperature rise heating module is configured to determine, at a first sampling frequency, a position of the region cold point on a temperature map at each sampling time point, and to control the heating device to heat the position of the region cold point, to adjust the average temperature of the food region from the first temperature to a second temperature, in which the temperature map is used to characterize temperature data of respective coordinate points of the cooking apparatus. The target temperature heating module is configured to collect a cooking parameter of each of the at least one ingredient, and to control, based on the cooking parameter, the heating device to adjust an average temperature of the ingredient from the second temperature to a target temperature.

In yet another aspect of the present disclosure, a cooking apparatus is further provided. The cooking apparatus includes: a memory; a processor; and a computer program stored on the memory and executable on the processor. The computer program processor, when executed by the processor, implements the temperature control method for the cooking apparatus according to any of the above embodiments.

In still yet another aspect of the present disclosure, a storage medium is further provided. A computer program is stored on the storage medium. The computer program, when executed by a processor, implements the temperature control method for the cooking apparatus according to any of the above embodiments.

Technical solutions of the above embodiments can provide at least one of the following advantageous effects.

With the temperature control method and system for the cooking apparatus, the cooking apparatus, and the storage medium provided by the present disclosure, the region cold point of the food region is collected in real time, which achieves even heating of the entire food region; and the heating device is controlled to perform targeted heating on individual ingredients based on the cooking parameters of the individual ingredients, thereby achieving an effect of getting the individual ingredients ready simultaneously with optimum cooking taste.

### BRIEF DESCRIPTION OF THE DRAWINGS

FIG. 1 is a flowchart of a temperature control method for a cooking apparatus in an aspect of the present disclosure;

FIG. 2 is a flowchart of cooking an ingredient by a cooking apparatus in an aspect of the present disclosure;

FIG. 3a is a schematic diagram of an initial temperature distribution in an infrared image in an aspect of the present disclosure;

FIG. 3b is a schematic diagram of a second temperature distribution in an infrared image in an aspect of the present disclosure;

FIG. 3c is a schematic diagram of a target temperature distribution in an infrared image in an aspect of the present disclosure;

FIG. 4 is a schematic diagram of an oven cavity coordinate system in an aspect of the present disclosure;

FIG. 5 is a block diagram of a temperature control system for a cooking apparatus in another aspect of the present disclosure;

FIG. 6 is a schematic diagram of an architecture of a cooking apparatus in yet another aspect of the present disclosure;

FIG. 7 is a schematic structural diagram of a cooking apparatus in still yet another aspect of the present disclosure; and

FIG. 8 is a schematic structural diagram of a computer-readable storage medium in still yet another aspect of the present disclosure.

### DESCRIPTION OF EMBODIMENTS

To provide a better understanding of the present disclosure, a detailed description of various aspects of the present disclosure will be made with reference to the accompanying drawings. It should be understood that the detailed description is merely a description of exemplary embodiments of the present disclosure and are not intended to limit the scope of the application in any way. Throughout the specification, same elements are denoted by same reference numerals. The expression “and/or” includes any and all combinations of one or more items in the listed items associated with the expression “and/or”.

It should be noted that in this specification, expressions such as “first”, “second”, and “third” are used only to distinguish one feature from another feature and do not indicate any limitation to the features, especially any order of precedence. Therefore, without departing from the teachings of the present disclosure, in the discussion of the present disclosure, a first document type may also be referred to as a second document type and a first document class may also be referred to as a second document class, and vice versa.

In the accompanying drawings, a thickness, a size, and a shape of each component have been slightly adjusted for ease of illustration. The accompanying drawings are examples only and are not drawn strictly to scale. As used herein, expressions “substantially”, “approximately”, or the like are used as expressions of approximation, rather than expressions of degree, and are intended to describe inherent deviations in measured or calculated values that are conceivable to those of ordinary skill in the art.

It should also be understood that expressions such as “include”, “comprise”, “have”, and/or “contain” are non-exclusive, rather than exclusive, expressions in this specification, which indicate a presence of a described feature, component and/or part, but do not exclude presence(s) of one or more other features, components and parts and/or a combination thereof. Furthermore, when an expression such as “at least one of . . . ” appears after a list of listed features, the expression modifies the entire list of the listed features, rather than an individual element in the list. In addition, in terms of description of embodiments of the present disclosure, the term “may” is used to indicate “one or more embodiments of the present disclosure”. Furthermore, the term “exemplary” is intended to refer to examples or example illustrations.

Unless otherwise limited, all expressions used herein (including engineering terms and technical terms) have the same meaning as commonly understood by those of ordinary skill in the art to which the present disclosure belongs. It should also be understood that, unless specified otherwise in the present disclosure, a word defined in a dictionary in common usage should be interpreted as having a meaning consistent with its meaning in the context of the related art, rather than being interpreted in an idealized or overly formal sense.

It should be noted that the embodiments and features in the embodiments of the present disclosure may be combined with each other without any conflict. Furthermore, unless expressly limited or contradicted with the context, specific steps contained in the method described in the present disclosure are not limited to a described sequence, and may be performed in any sequence or in parallel. The present disclosure will be described in detail below with reference to the accompanying drawings and in conjunction with embodiments.

Microwave ovens, toaster ovens, and other common cooking apparatuses used in home kitchens are popular among users due to their high heating efficiency, high cost performance, convenient operations, and other advantageous. At present, a cooking apparatus, which relies entirely on a predetermined cooking heating level and cooking time to heat up a to-be-cooked ingredient, cannot directly obtain temperature information and cooking state information on the to-be-cooked ingredient. Therefore, in order to achieve good cooking performance, the cooking heating level and the cooking time need to be set precisely. However, due to a relatively small number of built-in recipes in the cooking apparatus, a user often needs to customize the cooking heating level and the cooking time, which requires much user experience. In addition, since cooking parameters for different ingredients are different, normally only one ingredient can be cooked by a relevant cooking apparatus each time. When several ingredients are to be cooked, they need to be cooked separately, with the cooking heating level and the cooking time set separately. Obviously, cooking several ingredients by the relevant cooking apparatus is cumbersome, and enables cooking of the several ingredients not to be finished simultaneously with optimum cooking tastes, making it difficult to meet a user's need for a smart cooking apparatus.

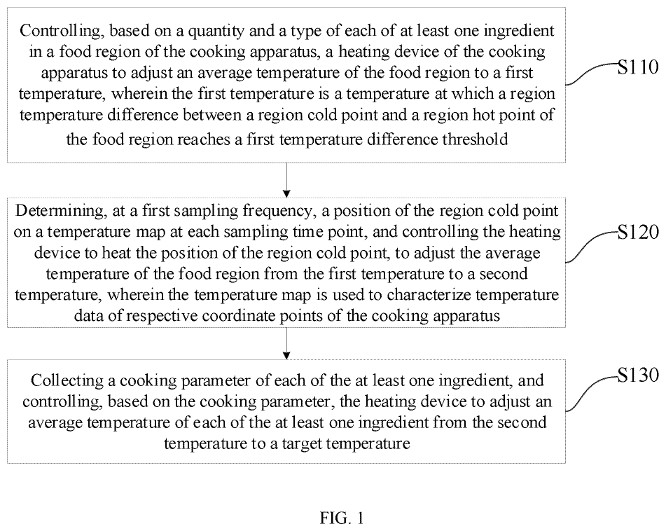

FIG. 1 is a flowchart of a temperature control method for a cooking apparatus in an aspect of the present disclosure.

As illustrated in FIG. 1, in view of the above problems, in an aspect of the present disclosure, a temperature control method for a cooking apparatus is provided. The temperature control method may include actions at blocks S110 to S130. At block S110, a heating device of the cooking apparatus is controlled based on a quantity and a type of at least one ingredient in a food region of the cooking apparatus to adjust an average temperature of the food region to a first temperature. The first temperature is a temperature at which a region temperature difference between a region cold point and a region hot point of the food region reaches a first temperature difference threshold. At block S120, a position of the region cold point on a temperature map at each sampling time point is determined at a first sampling frequency, and the heating device is controlled to heat the position of the region cold point, to adjust the average temperature of the food region from the first temperature to a second temperature. The temperature map is used to characterize temperature data of respective coordinate points of the cooking apparatus. At block S130, a cooking parameter of each of the at least one ingredient is collected, and the heating device is controlled based on the cooking parameter to adjust an average temperature of each of the at least one ingredient from the second temperature to a target temperature.

In some implementations, a first-stage heating is performed when a temperature of each pixel in the food region of the cooking apparatus is higher than a defrosting temperature. That is, the heating device of the cooking apparatus is controlled based on the quantity and the type of each of the at least one ingredient in the food region to perform a scan heating on the food region, enabling the average temperature of the food region to reach the first temperature. In some embodiments, the heating device includes a stirrer and a magnetron. The magnetron may be controlled based on the quantity and the type of each of the at least one ingredient in the food region to emit electromagnetic waves at a predetermined power. Then, the stirrer may be rotated at a predetermined speed to refract the electromagnetic waves evenly to various positions in the food region. The region cold point and the region hot point on the temperature map are collected in real time while the food region is heated by the heating device, and the region temperature difference between the region cold point and the region hot point is calculated in real time. The first-stage heating of the food region is stopped in response to the region temperature difference reaching the first temperature difference threshold. It should be noted that, the temperature map is used to characterize the temperature data of the respective coordinate points of the cooking apparatus. The first temperature is the temperature at which the region temperature difference between the region cold point and the region hot point of the food region reaches the first temperature difference threshold. The region cold point refers to a coordinate point corresponding to a lowest temperature value, on the temperature map, of the food region at respective time points. The region hot point refers to a coordinate point corresponding to a highest temperature value, on the temperature map, of the food region at respective time points. Of course, the region cold point may include a plurality of coordinate points distributed over the food region, and the region hot point may include a plurality of coordinate points distributed over the food region.

In some implementations, a second-stage heating is performed in response to the average temperature of the food region reaching the first temperature. That is, the position of the region cold point on the temperature map at each sampling time point is determined at the first sampling frequency, and the heating device is controlled to heat the position of the region cold point, to adjust the average temperature of the food region from the first temperature to the second temperature. The temperature map is used to characterize the temperature data of the respective coordinate points of the cooking apparatus. It should be noted that the second temperature is higher than the first temperature, and that the second-stage heating is further heating of the food region based on the first-stage heating. In some embodiments, when the region temperature difference between the region cold point and the region hot point on the temperature map is higher than the first temperature difference threshold, the position of the region cold point on the temperature map at each sampling time point is determined at the first sampling frequency. Further, the magnetron of the heating device is controlled based on the position of the region cold point at each sampling time point and the cooking parameter of the ingredient at the region cold point to emit electromagnetic waves at the predetermined power, and the stirrer of the heating device is controlled to refract the electromagnetic waves to the position of the region cold point, enabling the region cold point to receive a large amount of the electromagnetic waves. Furthermore, the above steps are repeated several times, and the second-stage heating is stopped in response to the average temperature of the food region reaching the second temperature. It should be noted that the second temperature may be set based on the cooking parameter of each of the at least one ingredient in the food region, or customized by the user based on his/her own cooking preferences, and the present disclosure is not limited thereto. Of course, when the heating device performs a fixed-point heating on the region cold point, a part of the food region other than the cold point region may also receive a certain amount of the electromagnetic waves. However, the energy of the electromagnetic waves received by the part of the food region other than the cold point region is much less than the energy of the electromagnetic waves received by a region to be defrosted, thereby realizing targeted rapid heating.

In some implementations, a third-stage heating is performed after the average temperature of the food region has reached the second temperature. That is, the cooking parameter of each of the at least one ingredient is collected, and the heating device is controlled based on the cooking parameter to adjust the average temperature of each of the at least one ingredient from the second temperature to the target temperature. In order to perform, on each of the at least one ingredient, targeted heating for achieving optimum cooking taste of each of the at least one ingredient, three heating methods may be applied in the third-stage heating based on different cooking parameters of different ingredients.

In some embodiments, the cooking parameter of each of the at least one ingredient includes an attribute, a target temperature rise value, and the target temperature of the ingredient. In some embodiments, the attribute of the ingredient includes homogenized food, non-homogenized food, and semi-homogenized food. The homogenized food has a characteristic of self-homogenizing an ingredient cold point and an ingredient hot point to enable an ingredient temperature difference between the ingredient cold point and the ingredient hot point to be smaller than or equal to a second temperature difference threshold, and includes liquid ingredients, e.g., milk, soya milk, etc. The non-homogenized food does not have the characteristic of self-homogenizing the ingredient cold point and ingredient hot point, and is susceptible to a situation where during the heating, the ingredient temperature difference between the ingredient cold point and the ingredient hot point is greater than an ingredient temperature difference threshold, and includes solid ingredients, e.g., rice, potatoes, etc. The semi-homogenized food falls into two categories: one category in which a same ingredient includes both a homogenized portion and a non-homogenized portion, which means that the same ingredient includes the homogenized portion having the attribute of the homogenized food and the non-homogenized portion having the attribute of the non- homogenized food, e.g., oat milk, porridge, etc.; and the other category in which a change in an attribute of a same ingredient occurs, which means that the attribute of the ingredient is a liquid state of the homogenized food in early heating, and the attribute of the ingredient changes to a solid state of the non-homogenized food as a temperature rises, e.g., an egg. It should be noted that the ingredient cold point refers to a coordinate point, corresponding to a lowest temperature value of any ingredient at respective time points, on the temperature map, and the ingredient hot point refers to a coordinate point, corresponding to a highest temperature value of any ingredient at respective time points, on the temperature map. Of course, the ingredient cold point may include a plurality of coordinate points of ingredient positions that is distributed over the temperature map, and the ingredient hot point may include a plurality of coordinate points of ingredient positions that is distributed over the temperature map. Different ingredients in the food region each have at least one ingredient cold point. The ingredient cold point having a lowest temperature value among all the ingredient cold points in the food region is the region cold point. Nevertheless, during the third-stage heating, emphasis is placed on the targeted heating for each ingredient, without paying attention to the position of the region cold point.

In some implementations, when the attribute of the ingredient is the homogenized food, the magnetron of the heating device is controlled based on the target temperature rise value and the target temperature of the ingredient to emit electromagnetic waves at the predetermined power. Then, the stirrer is rotated at a predetermined speed to refract the electromagnetic waves evenly to all positions of the ingredient, to adjust the average temperature of the ingredient from the second temperature to the target temperature.

In some implementations, when the attribute of the ingredient is the non-homogenized food, the position of the ingredient cold point of the ingredient on the temperature map at each sampling time point is determined at a second sampling frequency. Further, the magnetron of the heating device is controlled based on the target temperature rise value and the target temperature of the ingredient to emit electromagnetic waves at the predetermined power, and the stirrer of the heating device is controlled to refract the electromagnetic waves to the position of the ingredient cold spot, enabling the ingredient cold point to receive a large amount of the electromagnetic waves. Furthermore, the above steps are repeated several times until the average temperature of the ingredient reaches the target temperature.

In some implementations, when the attribute of the ingredient is the semi-homogenized food, different combination strategies are matched for different situations. In some embodiments, when the same ingredient includes the homogenized portion having the attribute of the homogenized food and the non-homogenized portion having the attribute of the non-homogenized food, a position of the homogenized portion and a position of the non-homogenized portion of the ingredient may be determined separately based on variations of the temperature rise values of different portions of the ingredient on the temperature map, for a reason that food having different attributes has different temperature rise values. Further, the magnetron of the heating device is controlled based on a target temperature rise value and a target temperature of the homogenized portion in the cooking parameter to emit electromagnetic waves at the predetermined power, and the stirrer is controlled to refract the electromagnetic waves evenly at a predetermined rotation speed, enabling the scan heating to be performed on the homogenized portion, thereby adjusting an average temperature of the homogenized portion from the second temperature to the target temperature. Further, a position of an ingredient cold point of the non-homogenized portion on the temperature map at each sampling time point is determined at the second sampling frequency. Further, the magnetron of the heating device is controlled based on a target temperature rise value and a target temperature of the non-homogenized portion in the cooking parameter to emit electromagnetic waves at the predetermined power, and the stirrer of the heating device is controlled to refract the electromagnetic waves to the position of the ingredient cold point, enabling the ingredient cold point to receive a large amount of the electromagnetic waves. Furthermore, the above steps are repeated several times until an average temperature of the non-homogenized portion reaches the target temperature.

In some implementations, when the attribute of the ingredient is the semi-homogenized food and variable between the homogenized food and the non-homogenized food, the ingredient cold point and the ingredient hot point of the ingredient are collected on the temperature map. When the ingredient temperature difference between the ingredient cold point and the ingredient hot point is smaller than or equal to the second temperature difference threshold, the magnetron of the heating device is controlled based on the target temperature rise value and the target temperature in the cooking parameter to emit electromagnetic waves at the predetermined power, and the stirrer of the heating device is controlled to refract the electromagnetic waves at the predetermined rotation speed to realize even scan heating of the ingredient. The even scan heating of the ingredient is stopped when the ingredient temperature difference between the ingredient cold point and the ingredient hot point is greater than the second temperature difference threshold. Further, the position of the ingredient cold point is determined. The heating device is controlled based on the target temperature rise value and the target temperature in the cooking parameter to heat the position of the ingredient cold point, to adjust the average temperature of the ingredient from the second temperature to the target temperature.

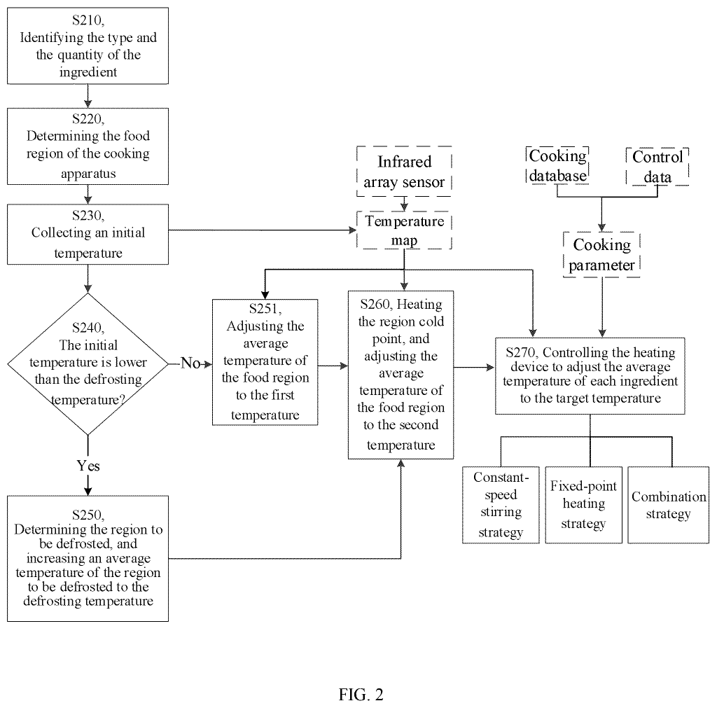

FIG. 2 is a flowchart of cooking an ingredient by a cooking apparatus in an aspect of the present disclosure.

As illustrated in FIG. 2, the flowchart of cooking the ingredient includes actions at blocks S210 to S270. At block S210, a type and a quantity of the ingredient are identified. At block S220, a food region of the cooking apparatus is determined. At block S230, an initial temperature is collected. At block S240, it is determined whether the initial temperature is lower than a defrosting temperature. At block S250, a region to be defrosted is determined, and an average temperature of the region to be defrosted is raised to a defrosting temperature. At block S251, an average temperature of the food region is adjusted to a first temperature. At block S260, a region cold point is heated, and the average temperature of the food region is adjusted to a second temperature. At block S270, a heating device is controlled to adjust an average temperature of each ingredient to the target temperature.

In some implementations, the type and the quantity of the ingredient are identified first. In some embodiments, when the user needs to cook at least one type of ingredient, for a packaged ingredient having a Quick Response (QR) code identifier or a barcode identifier, the QR code identifier or the barcode identifier characterizing ingredient information may be scanned by a QR code scanning device to obtain the type and the quantity of the ingredient. For example, a QR code identifier of braised prawns is scanned to obtain that the packaged ingredient is braised prawns and there are eight prawns in the braised prawns. Of course, for an unpackaged ingredient without the QR code identifier or the barcode identifier, a picture of the ingredient may be captured by an external camera of the cooking apparatus. The picture of the ingredient may be processed and analyzed by an ingredient recognition model to obtain the type and the quantity of the ingredient. For example, a picture of the braised prawns is captured by the external camera of the cooking apparatus and analyzed and processed by the ingredient recognition model. It is obtained that the type of the ingredient is braised prawns and there are eight prawns in the braised prawns. The ingredient recognition model may be a neural network model. The neural network model may be trained by a large number of training samples until a type and a quantity of the outputted ingredient meet an expectation, in which case the trained ingredient recognition model is obtained. Further, the picture of the ingredient is inputted to input neurons of the ingredient recognition model, and processed and analyzed by interneurons of the ingredient recognition model. The type and the quantity of the ingredient are finally outputted by output neurons of the ingredient recognition model. An output result of the ingredient recognition model trained with a large number of samples has credibility. Of course, in order to meet the user's personalized cooking need, the user may also input custom control data containing the type and the quantity of the ingredient from a control panel to allow the cooking taste of the ingredient to meet needs of different users. For example, the user may input, via the control panel, braised prawns as the type of the ingredient and eight as the quantity of the braised prawns.

In some implementations, after the type and the quantity of the ingredient are collected, at least one ingredient is placed in an ingredient carrying region within the cooking apparatus. Due to randomness of the type, the quantity, a shape, and a placement position of the ingredient, it is also necessary to determine the food region and a cavity region in the cooking apparatus after the ingredient has been placed into the cooking apparatus. Since a temperature difference exists between the ingredient and the cavity, temperature data of each pixel of the cooking apparatus may be collected by an infrared array sensor. Pixels having same or similar temperature data may be divided into a same region. Further, depending on types, quantities, and differences in storage temperatures of ingredients, the cooking apparatus may be divided into at least two regions, i.e., at least one ingredient region and a cavity region. A collection of a plurality of ingredient regions is defined as the food region. Of course, an image of the ingredient may also be captured by a built-in camera of the cooking apparatus. Further, the image of the ingredient captured by the built-in camera may be processed and analyzed by a food region determining model to determine the food region in the cooking apparatus. The food region determining model may be a neural network model.

For example, after braised prawns, braised eggplant, and beef are randomly placed into the cooking apparatus, positions where the braised prawns, the braised eggplant, and the beef are placed are determined as the food region, and a remaining region is determined as the cavity region. Further, since a temperature rise value of each of the braised prawns, the braised eggplant, and the beef is different from a temperature rise value of the air, a position of the food region may be determined through sensing temperature rise values at various positions within the cooking apparatus. For example, the temperature rise value of each of the braised prawns, the braised eggplant, and the beef ranges from a° C./s to c° C./s, while the temperature rise value of the air is d° C./s, which is much smaller than a° C./s. It is therefore proved that a position having a temperature rise value ranging from a° C./s to c° C./s is the food region, and a position having the temperature rise value of d° C./s is the cavity region. Of course, the image of the ingredient in the food region may also be captured by the built-in camera and processed and analyzed to identify and determine positions where the braised prawns, the braised eggplant, and the beef are located as the food region.

In some implementations, after the food region in the cooking apparatus has been determined, an initial temperature of each pixel in the food region is collected. Due to different storage methods of individual ingredients, an ingredient having the initial temperature lower than the defrosting temperature may exist. The defrosting temperature may be zero degrees Celsius. Further, a plurality of pixels each having an initial temperature lower than the defrosting temperature is determined from the initial temperature of each pixel in the food region, and positions of the plurality of pixels are integrated to obtain the region to be defrosted. Of course, the region to be defrosted may be distributed at different positions in the food region. Furthermore, the heating device of the cooking apparatus is controlled to heat the region to be defrosted to adjust an average temperature of the region to be defrosted to a defrosting temperature. For example, since the braised prawns are stored frozen in a refrigerator before placed into the cooking apparatus, its initial temperature is lower than the defrosting temperature. Therefore, a position where the braised prawns are located is defined as the region to be defrosted. The heating device of the cooking apparatus may be first controlled to heat the position where the braised prawns are located to rise an average temperature of the braised prawns to the defrosting temperature.

In some implementations, since optimum defrosting temperature rise values differ for different ingredients, the type and the quantity of an ingredient in the region to be defrosted may be also identified. The cooking parameter of the ingredient, i.e., the optimum defrosting temperature rise value, may be determined from a cooking database. An operating state of the heating device of the cooking apparatus may be set to allow the heating device of the cooking apparatus to defrost the ingredient within a range of optimum defrosting temperature rise values of the ingredient, which maximizes the cooking taste of the ingredient. For example, when the type of the ingredient is braised prawns and there are eight prawns, an optimum defrosting temperature rise value for the eight braised prawns obtained from the cooking database is a° C./s. Therefore, the heating device of the cooking apparatus can be controlled to heat the braised prawns at the temperature rise value of a° C./s.

In some implementations, the heating device of the cooking apparatus may include the magnetron and the stirrer. The magnetron is configured to emit electromagnetic waves at the predetermined power into an oven cavity of the cooking apparatus. The stirrer is configured to refract the electromagnetic waves emitted by the magnetron. An angle of refraction may be determined by a position of the region to be defrosted. For example, when the region to be defrosted in the cooking apparatus needs to be heated, the electromagnetic waves emitted by the magnetron are refracted by the stirrer to the region to be defrosted to achieve a fixed-point heating of the region to be defrosted. Of course, in this case, a region in the food region other than the region to be defrosted may also receive a certain amount of the electromagnetic waves. However, the energy of the electromagnetic waves received by the region in the food region other than the region to be defrosted is much less than the energy of the electromagnetic waves received by the region to be defrosted, thereby achieving targeted rapid defrosting.

In some implementations, in order to monitor a cooking state of the food region in real time, a cooking state monitoring device and an infrared array sensor are activated as soon as the heating device of the cooking apparatus starts to operate. In some embodiments, the cooking state monitoring device is configured to collect a cooking state of the ingredient in real time and transmit the cooking state to a display device, e.g., a user end, in real time, to enable the user to monitor the cooking state of the ingredient in real time. The infrared array sensor is configured to collect temperature data of the food region and draw an infrared image for characterizing the temperature data, to visualize temperature distribution in the generated temperature map.

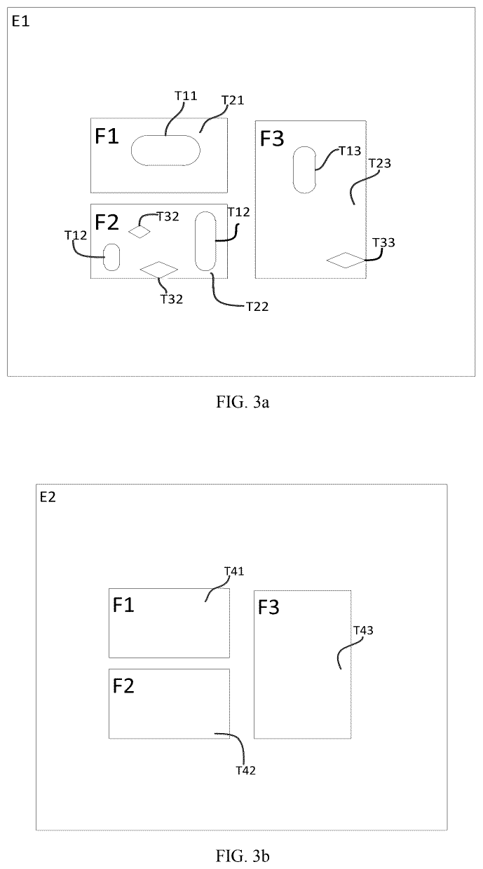

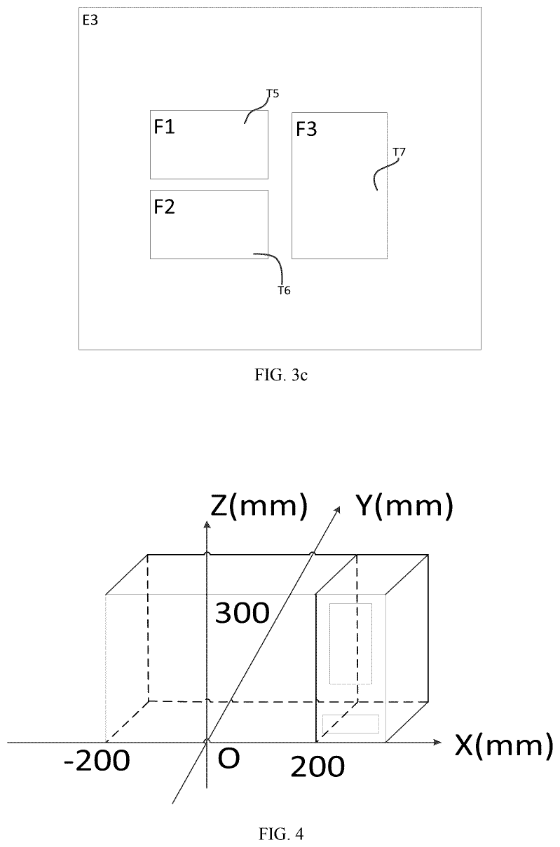

FIG. 3a is a schematic diagram of an initial temperature distribution in the infrared image in an aspect of the present disclosure. FIG. 3b is a schematic diagram of a second temperature distribution in the infrared image in an aspect of the present disclosure. FIG. 3c is a schematic diagram of a target temperature distribution in the infrared image in an aspect of the present disclosure.

As illustrated in FIG. 3a, after the heating device of the cooking apparatus has started to operate, the infrared array sensor is activated. The infrared array sensor collects the initial temperature of the food region and draws the infrared image for characterizing the temperature data of the food region. For example, at an initial stage when each ingredient is placed in the food region, an ambient temperature of the cavity of the cooking apparatus is a temperature value E1. A first ingredient F1 has a region to be defrosted having an initial temperature of a temperature value T11 smaller than or equal to the defrosting temperature. Also, the first ingredient F1 has a room temperature region having an initial temperature of a temperature value T21 greater than the defrosting temperature but smaller than the first temperature. A second ingredient F2 has a plurality of regions to be defrosted each having an initial temperature of a temperature value T12 smaller than or equal to the defrosting temperature. Also, the second ingredient F2 has a room temperature region having an initial temperature of a temperature value T22 greater than the defrosting temperature but smaller than the first temperature. The second ingredient F2 also has a relatively high-temperature region having an initial temperature of a temperature value T32 greater than or equal to the first temperature. A third ingredient F3 has a region to be defrosted having an initial temperature of a temperature value T13 smaller than or equal to the defrosting temperature. Also, the third ingredient F3 has a room temperature region having an initial temperature of a temperature value T23 greater than the defrosting temperature but smaller than the first temperature. The third ingredient F3 also has a relatively high-temperature region having an initial temperature of a temperature value T33 greater than or equal to the first temperature. More intuitively, the infrared image indicates magnitudes of the temperature data by colors. For example, a temperature of a position indicated in the red color is higher than or equal to one hundred degrees Celsius, a temperature of a position indicated in the blue color is lower than or equal to zero degrees Celsius, and temperatures at remaining positions correspond, from high to low, to transition colors between the red color and blue color. Therefore, a region corresponding to the temperature value T11, a region corresponding to the temperature value T12, and a region corresponding to the temperature value T13 are indicated in the blue color, a region corresponding to the temperature value T21, a region corresponding to the temperature value T22, and a region corresponding to the temperature value T23 are indicated in the green color, and a region corresponding to the temperature value T32 and a region corresponding to the temperature value T33 are indicated in the yellow color.

As illustrated in FIG. 3b, in response to the temperature of each ingredient in the food region reaching the second temperature, the infrared array sensor collects the temperature data of the food region and draws an infrared image for characterizing the temperature data of the food region. For example, in response to the average temperature of all the ingredients reaching the second temperature, the ambient temperature of the cavity of the cooking apparatus is a temperature value E2. A heating at this stage is a fixed-point heating of a cold point position of each ingredient. Therefore, different positions of a same ingredient have approximate temperature values. That is, an average temperature of the first ingredient F1 is of a temperature value T41, an average temperature of the second ingredient F2 is of a temperature value T42, and an average temperature of the third ingredient F3 is of a temperature value T43. In this case, each ingredient has no obvious relatively high-temperature region, let alone the region to be defrosted. It should be noted that in this case, the temperature value T41, the temperature value T42, and the temperature value T43 are all greater than the second temperature and smaller than the target temperature. More intuitively, a region corresponding to the temperature value T41, a region corresponding to the temperature value T42, and a region corresponding to the temperature value T43 are all indicated in the orange color. Of course, in terms of numerical values of temperature values, saturation of the orange color increases as the temperature value of the region increases.

As illustrated in FIG. 3c, in response to the temperature of the food region reaching the target temperature of each ingredient, the infrared array sensor collects the temperature data of the food region and draws an infrared image for characterizing the temperature data of each ingredient in the food region. For example, in response to the average temperature of each ingredient reaching the target temperature, the ambient temperature of the cavity of the cooking apparatus is of a temperature value E3, the average temperature of the first ingredient F1 is of a temperature value T5, the average temperature of the second ingredient F2 is of a temperature value T6, and the average temperature of the third ingredient F3 is of a temperature value T7. It should be noted that the temperature values T5, T6, and T7 are the target temperatures of the first ingredient F1, the second ingredient F2, and the third ingredient F3, respectively. More intuitively, a region corresponding to the temperature value T5, a region corresponding to the temperature value T6, and a region corresponding to the temperature value T7 are all indicated in the red color. Of course, in terms of numerical values of temperature, saturation of the red color increases as numerical values of temperature of the region increases.

FIG. 4 is a schematic diagram of an oven cavity coordinate system in an aspect of the present disclosure.

In some implementations, dimensional data of the cooking apparatus is detected first. An oven cavity coordinate system is established based on the dimensional data of the cooking apparatus. As illustrated in FIG. 4, the oven cavity coordinate system includes a horizontal coordinate axis, i.e., the X-axis, a longitudinal coordinate axis, i.e., the Y-axis, a vertical coordinate axis, i.e., the Z-axis, and a coordinate origin, i.e., point O. A unit of each coordinate axis of the oven cavity coordinate system is in millimeters (mm). In the present disclosure, the coordinate origin of the oven cavity coordinate system is a midpoint of a lower edge of an oven cavity door of the cooking apparatus. Horizontal coordinates of left and right endpoints of the oven cavity door of the cooking apparatus are −200 and 200, respectively. A vertical coordinate of a midpoint of an upper edge of the oven cavity door of the cooking apparatus is 300. Obviously, the oven cavity coordinate system is use to characterize a three-dimensional position of each pixel of the cooking apparatus in a form of a coordinate point to realize precise positioning of each pixel. Further, the infrared array sensor continuously collects the temperature data of each pixel of the cooking apparatus. Furthermore, the temperature data of each pixel of the cooking apparatus is mapped to the oven cavity coordinate system to generate the temperature map. The temperature map is used to characterize temperature data of each coordinate point of the cooking apparatus to facilitate accurate positioning of the region cold point, the region hot point, the ingredient cold point, and the ingredient hot point and accurate obtaining of parameters such as a region average temperature and an ingredient average temperature in subsequent steps. It should be noted that, the region cold point refers to a coordinate point corresponding to a lowest temperature value, on the temperature map, of the food region at respective time points, and the region hot point refers to a coordinate point corresponding to a highest temperature value, on the temperature map, of the food region at respective time points. The ingredient cold point refers to a coordinate point corresponding to a lowest temperature value, on the temperature map, of any ingredient at respective time points. The ingredient hot point refers to a coordinate point corresponding to a highest temperature value, on the temperature map, of any ingredient at respective time points.

In some implementations, the infrared array sensor continuously collects the temperature data of each coordinate point of the cooking apparatus, and updates the temperature data of each coordinate point of the temperature map in real time based on the real-time temperature data, to ensure accurate and real-time temperature monitoring, which is conducive to improving the cooking taste of each ingredient.

It should be noted that different ingredients have different temperature rise values. when increasing the average temperature of the region to be defrosted to the defrosting temperature, or in other heating processes of the ingredient, an actual temperature rise value of the ingredient may be matched to the type of the ingredient from the cooking database. By using the temperature rise value to determine the type of the ingredient, accuracy of identification of the type of the ingredient can be improved. The temperature rise value can also be used to assist in determining the type of the ingredient when the type of the ingredient fails to be identified using the above method for identifying the type of the ingredient.

In some implementations, it is also necessary to pre-generate the cooking database to obtain, based on the type of the ingredient, the cooking parameter, thereby achieving precise heating of the ingredient. In some embodiments, cooking parameters corresponding to types of a plurality of ingredients may be obtained from a cloud and a user end, including cooking parameters corresponding to different ways of cooking for a same ingredient and cooking parameters corresponding to the same ingredient when cooked along with different ingredients. Further, the types of the plurality of ingredients and the cooking parameters corresponding to the types of the plurality of ingredients are integrated to obtain the cooking database. It should be noted that the cooking parameter includes the attribute, the target temperature rise value, and the target temperature of the ingredient. In some embodiments, the attribute of the ingredient may include the homogenized food, the non-homogenized food, and the semi-homogenized food. The target temperature rise value is a temperature variation required to achieve the optimum cooking taste of the ingredient. The target temperature is a highest cooking temperature required to achieve the optimum cooking taste of the ingredient.

In some implementations, after the cooking database has been generated, it is necessary to update the cooking database with the type and the cooking parameter of the ingredient in a predetermined update cycle, enabling the cooking database to meet a wider range of cooking needs.

In some implementations, in response to the average temperature of the region to be defrosted of the cooking apparatus reaching the defrosting temperature, the first-stage heating is performed. That is, the heating device of the cooking apparatus is controlled based on the quantity and the type of the ingredient in the food region to perform the scan heating on the food region, enabling the average temperature of the food region to reach the first temperature. In some embodiments, the heating device includes the stirrer and the magnetron. The magnetron may be controlled based on the quantity and the type of the ingredient in the food region, to emit electromagnetic waves at the predetermined power. Then, the stirrer may be rotated at the predetermined speed (e.g., 0.2 degrees per second) to refract the electromagnetic waves evenly to various positions in the food region. When the food region is heated by the heating device, the region cold point and the region hot point on the temperature map are collected in real time, and the region temperature difference between the region cold point and the region hot point is calculated in real time. The first-stage heating of the food region is stopped in response to the region temperature difference reaching the first temperature difference threshold (e.g., 5 degrees Celsius).

In some implementations, the second-stage heating is performed in response to the average temperature of the food region reaching the first temperature. That is, the position of the region cold point on the temperature map at each sampling time point is determined at the first sampling frequency, and the heating device is controlled to heat the position of the region cold point, to adjust the average temperature of the food region from the first temperature to the second temperature. The temperature map is used to characterize the temperature data of the respective coordinate points of the cooking apparatus. It should be noted that the second temperature is higher than the first temperature and that the second-stage heating is further heating of the food region based on the result of the first-stage heating. In some embodiments, when the region temperature difference between the region cold point and the region hot point on the temperature map is higher than the first temperature difference threshold, the position of the region cold point on the temperature map at each sampling time point is determined at the first sampling frequency. Further, the magnetron of the heating device is controlled based on the position of the region cold point at each sampling time point and the cooking parameter of the ingredient at the region cold point to emit electromagnetic waves at the predetermined power, and the stirrer of the heating device is controlled to refract the electromagnetic waves to the position of the region cold point, enabling the region cold point to receive a large amount of the electromagnetic waves. Furthermore, the above steps are repeated several times, and until the average temperature of the food region reaches the second temperature, at which the second-stage heating is stopped. Of course, when the heating device performs the fixed-point heating on the region cold point, the part of the food region other than the region cold point may also receive a certain amount of the electromagnetic waves. However, the energy of the electromagnetic waves received by the part of the food region other than the region cold point is much less than the energy of the electromagnetic waves received by the region to be defrosted, thereby realizing targeted rapid heating. For example, when the region cold point exists in the braised prawns, the region cold point is heated until a new region cold point appears. The heating device is controlled to heat the new region cold point until the average temperature of the braised prawns reaches the second temperature, at which the second-stage heating is stopped.

In some implementations, after the average temperature of the food region has been heated to the second temperature, the cooking parameter of each ingredient is obtained to perform targeted heating on each ingredient, thereby ensuring its optimum cooking taste. In some embodiments, since users' needs differ for the cooking taste of different ingredients, the cooking parameter may be obtained by analyzing the control data inputted by the user. The control data includes a heating level, time, and the type of the ingredient. Of course, also, the type of the ingredient may be collected. The cooking parameter corresponding to the type of the ingredient may be obtained from the cooking database. Further, the heating device is controlled based on the cooking parameter of each ingredient to adjust the average temperature of the ingredient to the target temperature in a target operation state. It should be noted that the cooking apparatus can control, based on the cooking parameter, the magnetron of the heating device to emit the electromagnetic waves at the target power, further control, based on the cooking parameter, the stirrer of the heating device to refract the electromagnetic waves from the magnetron in accordance with a target operation strategy, and adjust the average temperature of the ingredient from the second temperature to the target temperature through cooperation between the magnetron and the stirrer. In some embodiments, the target operation strategy of the stirrer includes a constant-speed stirring strategy and a fixed-point heating strategy. The fixed-point heating strategy includes controlling the stirrer to refract the electromagnetic waves from the magnetron to the position of the region cold point or the position of the ingredient cold point to enable the region cold point or the ingredient cold point to receive a large amount of the electromagnetic waves.

In some implementations, the third-stage heating is performed after the average temperature of the food region has reached the second temperature. That is, the cooking parameter of each ingredient is collected, and the heating device is controlled based on the cooking parameter to adjust the average temperature of the ingredient from the second temperature to the target temperature. To perform the targeted heating on the ingredient for achieving the optimum cooking taste of the ingredient, three ways of heating may be applied in the third-stage heating based on different cooking parameters of different ingredients.

In some embodiments, the cooking parameter of the ingredient includes the attribute, the target temperature rise value, and the target temperature of the ingredient. In some embodiments, the attribute of the ingredient includes homogenized food, non-homogenized food, and semi-homogenized food. The homogenized food has a characteristic of self-homogenizing the ingredient cold point and the ingredient hot point to enable the ingredient temperature difference between the ingredient cold point and the ingredient hot point to be smaller than or equal to the second temperature difference threshold, and includes liquid ingredients, e.g., milk, soya milk, etc. The non-homogenized food does not have the characteristic of self-homogenizing the ingredient cold point and ingredient hot point, and is susceptible to a situation where during the heating, the ingredient temperature difference between the ingredient cold point and the ingredient hot point is greater than the ingredient temperature difference threshold, and includes solid ingredients, e.g., rice, potatoes, etc. The semi-homogenized food falls into two categories: one category in which a same ingredient includes both the homogenized portion and the non-homogenized portion, which means that the same ingredient includes the homogenized portion having the attribute of homogenized food and the non-homogenized portion having the attribute of non-homogenized food, e.g., oat milk, porridge, etc.; and the other category in which a change in an attribute of a same ingredient occurs, which means that the attribute of the ingredient is the liquid state of the homogenized food in early heating, and as the temperature rises, the attribute of the ingredient changes to the solid state of the non-homogenized food, e.g., an egg. It should be noted that the ingredient cold point refers to a coordinate point, corresponding to a lowest temperature value of any ingredient at respective time points, on the temperature map, and the ingredient hot point refers to a coordinate point, corresponding to a highest temperature value of any ingredient at respective time points, on the temperature map. Of course, the ingredient cold point may include a plurality of coordinate points of ingredient positions that is distributed over the temperature map, and the ingredient hot point may include a plurality of coordinate points of ingredient positions that is distributed over the temperature map. Different ingredients in the food region each have at least one ingredient cold point. The ingredient cold point having the lowest temperature value among all the ingredient cold points in the food region is the region cold point. Of course, in the third-stage heating, emphasis is placed on the targeted heating for each ingredient, without paying attention to the position of the region cold point.

In some implementations, when the attribute of the ingredient is the homogenized food, e.g., milk, soybean milk, etc., the magnetron of the heating device is controlled based on the target temperature rise value and the target temperature of the ingredient to emit electromagnetic waves at the predetermined power. Then, the stirrer is rotated at a predetermined speed to refract the electromagnetic waves evenly to all positions of the ingredient, to adjust the average temperature of the ingredient from the second temperature to the target temperature.

In some implementations, when the attribute of the ingredient is the non- homogenized food, e.g., rice, potatoes, etc., the position of the ingredient cold point of the ingredient on the temperature map at each sampling time point is determined at the second sampling frequency. Further, the magnetron of the heating device is controlled based on the target temperature rise value and the target temperature of the ingredient to emit electromagnetic waves at the predetermined power, and the stirrer of the heating device is controlled to refract the electromagnetic waves to the position of the ingredient cold spot, enabling the ingredient cold point to receive a large amount of the electromagnetic waves. Furthermore, the above steps are repeated until the average temperature of the ingredient reaches the target temperature.

In some implementations, when the attribute of the ingredient is the semi- homogenized food, different combination strategies are matched for different situations. In some embodiments, when the same ingredient includes the homogenized portion having the attribute of the homogenized food and the non-homogenized portion having the attribute of the non-homogenized food, e.g., oat milk, porridge, etc., a position of the homogenized portion and a position of the non-homogenized portion of the ingredient may be determined separately based on variations of the temperature rise values of different portions of the ingredient on the temperature map, for a reason that food having different attributes has different temperature rise values. For example, oat milk includes the non-homogenized portion such as oats and the homogenized portion such as milk. Since a temperature rise value is m° C./s for oats and is n° C./s for milk, a position may be proved as oats when it is obtained from the temperature map that the position has a temperature rise value of m° C./s. That is, the position is the non-homogenized portion and the remaining portion is the homogenized portion such as milk. Further, the magnetron of the heating device is controlled based on the target temperature rise value and the target temperature of the homogenized portion in the cooking parameter to emit electromagnetic waves at the predetermined power, and the stirrer is controlled to refract the electromagnetic waves evenly at the rotation predetermined speed, to perform the scan heating on the homogenized portion, to adjust the average temperature of the homogenized portion to from the second temperature to the target temperature. Furthermore, the position of the ingredient cold point of the non-homogenized portion on the temperature map at each sampling time point is determined at the second sampling frequency. Further, the magnetron of the heating device is controlled based on the target temperature rise value and the target temperature of the non-homogenized portion in the cooking parameter to emit electromagnetic waves at the predetermined power, and the stirrer of the heating device is controlled to refract the electromagnetic waves to the position of the ingredient cold point, enabling the ingredient cold point to receive a large amount of the electromagnetic waves. Furthermore, the above steps are repeated several times until the average temperature of the non-homogenized portion reaches the target temperature.

In some implementations, when the attribute of the ingredient is the semi- homogenized food and variable between the homogenized food and the non-homogenized food, e.g., a steamed egg custard, the ingredient cold point and the ingredient hot point of the ingredient are collected on the temperature map. When the ingredient temperature difference between the ingredient cold point and the ingredient hot point is smaller than or equal to the second temperature difference threshold, the magnetron of the heating device is controlled based on the target temperature rise value and the target temperature in the cooking parameter to emit electromagnetic waves at the predetermined power, and the stirrer of the heating device is controlled to refract the electromagnetic waves at the predetermined rotation speed to realize even scan heating of the ingredient. The even scan heating of the ingredient is stopped when the ingredient temperature difference between the ingredient cold point and the ingredient hot point is greater than the second temperature difference threshold. Further, the position of the ingredient cold point is determined. The heating device is controlled based on the target temperature rise value and the target temperature in the cooking parameter to heat the position of the ingredient cold point, to adjust the average temperature of the ingredient from the second temperature to the target temperature. For example, when the ingredient is the egg custard in the liquid state, the heating device is controlled to perform even scan heating on the egg custard until the ingredient temperature difference between the ingredient cold point and the ingredient hot point of the egg custard is greater than the second temperature difference threshold, at which the even scan heating is stopped. Thereafter, the heating device is controlled to perform the fixed-point heating on the position of the ingredient cold point of the egg custard, enabling an average temperature of the egg custard to reach the target temperature.

With the temperature control method for the cooking apparatus of the present disclosure, the region cold point of the food region is collected in real time, which achieves even heating of the entire food region. In addition, the heating device is controlled to perform the targeted heating on individual ingredients based on the cooking parameters of the individual ingredients, thereby achieving an effect of getting the individual ingredients ready simultaneously with optimum cooking taste.

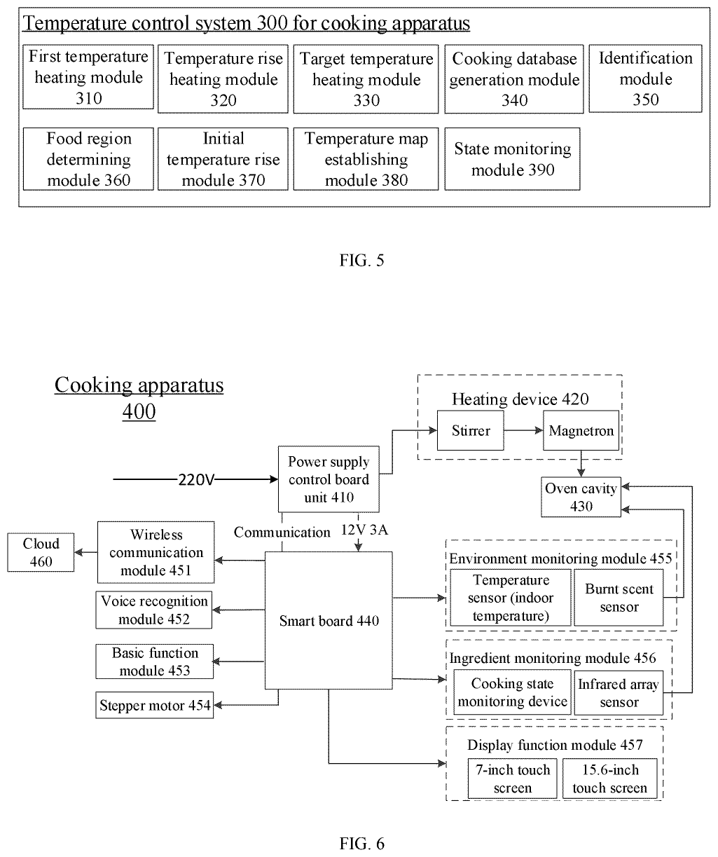

FIG. 5 is a block diagram of a temperature control system for a cooking apparatus in another aspect of the present disclosure.

As illustrated in FIG. 5, in another aspect of the present disclosure, a temperature control system 300 for a cooking apparatus is further provided. The temperature control system 300 may include a first temperature heating module 310, a temperature rising heating module 320, and a target temperature heating module 330. The first temperature heating module 310 is configured to control, based on a quantity and a type of each of at least one ingredient in a food region of the cooking apparatus, a heating device of the cooking apparatus to adjust an average temperature of the food region to a first temperature. The first temperature is a temperature at which a region temperature difference between a region cold point and a region hot point of the food region reaches a first temperature difference threshold. The temperature rise heating module 320 is configured to determine, at a first sampling frequency, a position of the region cold point on a temperature map at each sampling time point, and control the heating device to heat the position of the region cold point, to adjust the average temperature of the food region from the first temperature to a second temperature. The temperature map is used to characterize temperature data of respective coordinate points of the cooking apparatus. The target temperature heating module 330 is configured to collect a cooking parameter of each ingredient, and control, based on the cooking parameter, the heating device to adjust an average temperature of the ingredient from the second temperature to a target temperature.

In some implementations, performing steps of the target temperature heating module 330 include: collecting the cooking parameter of each ingredient, in which the cooking parameter includes an attribute, a target temperature rise value, and the target temperature of the ingredient; and controlling, when the attribute of the ingredient is homogenized food, the heating device to perform the scan heating on the ingredient based on the target temperature rise value and the target temperature of the ingredient, to adjust the average temperature of the ingredient from the second temperature to the target temperature.

In some implementations, performing steps of the target temperature heating module 330 include: collecting the cooking parameter of each ingredient, in which the cooking parameter including an attribute, a target temperature rise value, and the target temperature of the ingredient; determining, when the attribute of the ingredient is non-homogenized food, at a second sampling frequency, a position of an ingredient cold point of the ingredient on the temperature map at each sampling time point; and controlling, based on the target temperature rise value and the target temperature of the ingredient, the heating device to heat the position of the ingredient cold point, to adjust the average temperature of the ingredient from the second temperature to the target temperature.

In some implementations, the performing steps of the target temperature heating module 330 include: collecting the cooking parameter of each ingredient, in which the cooking parameter includes an attribute, a target temperature rise value, and the target temperature of the ingredient; determining, when the attribute of the ingredient is semi-homogenized food, a position of a homogenized portion of the ingredient and a position of a non-homogenized portion of the ingredient based on the temperature map, in which the ingredient includes the homogenized portion having an attribute of homogenized food and the non-homogenized portion having an attribute of non-homogenized food; controlling, based on the cooking parameter, the heating device to perform a scan heating on homogenized portion, to adjust an average temperature of the homogenized portion from the second temperature to the target temperature; determining, at a second sampling frequency, a position of an ingredient cold point of the non-homogenized portion on the temperature map at each sampling time point; and controlling, based on the cooking parameter, the heating device to heat the position of the ingredient cold point, to adjust an average temperature of the non-homogenized portion from the second temperature to the target temperature.

In some implementations, the performing steps of the target temperature heating module 330 include: collecting the cooking parameter of each of the at least one ingredient, the cooking parameter including an attribute, a target temperature rise value, and the target temperature of the ingredient; collecting, when the attribute of the ingredient is semi- homogenized food, an ingredient cold point and an ingredient hot point on the temperature map at a second sampling frequency, in which the attribute of the ingredient is variable between homogenized food and non-homogenized food; controlling, when an ingredient temperature difference between the ingredient cold point and the ingredient hot point is smaller than or equal to a second temperature difference threshold, the heating device to perform a scan heating on the ingredient based on the cooking parameter; determining, when the ingredient temperature difference between the ingredient cold point and the ingredient hot point is greater than the second temperature difference threshold, a position of the ingredient cold point; and controlling, based on the cooking parameter, the heating device to heat the position of the ingredient cold point, to adjust the average temperature of the ingredient from the second temperature to the target temperature.

In some implementations, controlling, based on the cooking parameter, the heating device to adjust the average temperature of each ingredient from the second temperature to the target temperature includes: controlling, based on the cooking parameter, a magnetron of the heating device to emit electromagnetic waves at a target power; controlling, based on the cooking parameter, a stirrer of the heating device to refract the electromagnetic waves from the magnetron in accordance with a target operation strategy; and adjusting the average temperature of the ingredient from the second temperature to the target temperature through cooperation between the magnetron and the stirrer.

In some implementations, the target operation strategy of the stirrer includes a constant-speed stirring strategy and a fixed-point heating strategy. The fixed-point heating strategy is to control the stirrer to refract the electromagnetic waves from the magnetron to a position of the region cold point or a position of an ingredient cold point, enabling the region cold point or the ingredient cold point to receive a large amount of the electromagnetic waves.

In some implementations, collecting the cooking parameter of each ingredient includes: analyzing inputted control data to obtain the cooking parameter, in which the inputted control data includes a heating level, time, and the type of each of the ingredient; or collecting the type of the ingredient, and obtaining the cooking parameter of the ingredient from a cooking database.

In some implementations, the temperature control system 300 may further include a cooking database generation module 340. The cooking database generation module 340 is configured to: obtain cooking parameters corresponding to types of a plurality of ingredients from a cloud and a user end; and integrate the types of the plurality of ingredients and the cooking parameters corresponding to the types of the plurality of ingredients to obtain the cooking database.

In some implementations, the temperature control system 300 may further include a database update module (not illustrated). The database update module is configured to update the cooking database at a predetermined update cycle.

In some implementations, the temperature control system 300 may further include an identification module 350. The identification module 350 is configured to identify the type and the quantity of the ingredient.

In some implementations, performing steps of the identification module 350 include: scanning a QR code identifier for characterizing ingredient information by a QR code scanning device, to obtain the type and the quantity of the ingredient; capturing a picture of the ingredient by an external camera, and analyzing the picture of the ingredient by an ingredient recognition model, to obtain the type and the quantity of the ingredient; or collecting control data including the type and the quantity of the ingredient from a control panel.

In some implementations, the temperature control system 300 may further include a food region determining module 360. The food region determining module 360 is configured to: collect temperature data of each pixel of the cooking apparatus by an infrared array sensor; and determine the food region of the cooking apparatus based on the temperature data.

In some implementations, the temperature control system 300 may further include an initial temperature rise module 370. The initial temperature rise module 370 is configured to: collect an initial temperature of each pixel in the food region; select a plurality of pixels each having the initial temperature lower than a defrosting temperature, and determine positions of the plurality of pixels as a region to be defrosted; control the heating device of the cooking apparatus to heat the region to be defrosted to increase an average temperature of the region to be defrosted to the defrosting temperature; and control, in response to detecting that the average temperature of the region to be defrosted reaches the defrosting temperature, the heating device of the cooking apparatus based on the quantity and the type of the ingredient in the food region of the cooking apparatus, to adjust the average temperature of the food region to the first temperature.

In some implementations, the temperature control system 300 may further include a temperature map establishing module 380. The temperature map establishing module 380 is configured to: detect dimensional data of the cooking apparatus, and establish an oven cavity coordinate system based on the dimensional data, in which the oven cavity coordinate system is use to characterize a three-dimensional position of each pixel of the cooking apparatus in a form of coordinate points; collect the temperature data of each pixel of the cooking apparatus by the infrared array sensor; and map the temperature data of each pixel of the cooking apparatus to the oven cavity coordinate system to generate the temperature map, in which the temperature map is used to characterize temperature data of each coordinate point of the cooking apparatus.

In some implementations, the temperature control system 300 may further include a temperature map update module (not illustrated). The temperature map update module is configured to collect the temperature data of each coordinate point of the cooking apparatus in real time to update the temperature map in real time.

In some implementations, the temperature control system 300 may further include a state monitoring module 390. The state monitoring module 390 is configured to: activate a cooking state monitoring device to collect a cooking state of the ingredient in real time; and feed the cooking state back to a user end.

With the temperature control system for the cooking apparatus of the present disclosure, the region cold point of the food region is collected in real time, which achieves even heating of the entire food region. In addition, the heating device is controlled to perform the targeted heating on individual ingredients based on the cooking parameters of the individual ingredients, thereby achieving an effect of getting the individual ingredients ready simultaneously with optimum cooking taste.

FIG. 6 is a schematic diagram of an architecture of a cooking apparatus in yet another aspect of the present disclosure.

As illustrated in FIG. 6, a cooking apparatus 400 includes a power supply control board unit 410, a heating device 420, an oven cavity 430, a smart board 440, a wireless communication module 451, a voice recognition module 452, a basic function module 453, a stepper motor 454, an environment monitoring module 455, an ingredient monitoring module 456, a display function module 457, and a cloud 460. In some embodiments, the heating device 420 includes a stirrer and a magnetron. The environment monitoring module 455 includes a temperature sensor and a burnt scent sensor. The ingredient monitoring module 456 includes a cooking state monitoring device, and an infrared array sensor. The display function module 457 may be a 7-inch or 15.6-inch touch screen.

In some embodiments, an electrical signal having a 220V input voltage is provided to the cooking apparatus 300 by a power supply. In some embodiments, the electrical signal having the 220V input voltage is transmitted through a protection board (not illustrated) to the power supply control board unit 410. Further, the power supply control board unit 410 processes the inputted electrical signal to enable the processed electrical signal to meet needs of other electrical modules within the cooking apparatus 400. For example, the power supply control board unit 410 steps down the inputted electrical signal to provide an electrical signal having a voltage of 12V and a current of 3A to the smart board 440. Also, the power supply control board unit 410 also provides the heating unit 420 with an electrical signal that meets its electrical requirements. In addition, the power supply control board unit 410 is also provided with a communication interface, e.g., a Universal Asynchronous Receiver Transmitter (UART), configured for further data interaction with the smart board 440. Of course, the cooking apparatus 400 may also include a plurality of fans (not illustrated) and a micro switch (not illustrated). Four fans may be provided to assist the power supply control board unit 410 in dissipating heat.

In some embodiments, the heating device 420 interacts with the power supply control board unit 410 in a control signal, and the control signal is capable of controlling, in response to the temperature control method for the cooking apparatus according to any of the embodiments of the present disclosure, both the target stirring strategy of the stirrer and the target power of the magnetron of the heating device 420. In some embodiments, the control signals may include: emitting electromagnetic waves by the magnetron at a predetermined power, and performing, by the stirrer, fixed-point refraction on an electromagnetic wave signal to the region to be defrosted of the food region in the oven cavity 430; emitting the electromagnetic waves by the magnetron at the predetermined power, and refracting, by the stirrer, the electromagnetic waves evenly to the food region in the oven cavity 430; emitting the electromagnetic waves by the magnetron at the predetermined power, and performing, by the stirrer, fixed-point refraction on the electromagnetic waves to the region cold point of the food region; emitting the electromagnetic waves by the magnetron at the predetermined power, and performing, by the stirrer, fixed-point refraction on the electromagnetic waves to the ingredient cold point of each ingredient; and emitting the electromagnetic waves by the magnetron at the predetermined power, and refracting the electromagnetic waves evenly to each ingredient by the stirrer. The magnetron and the stirrer stop operating in response to each ingredient reaching the target temperature.

In some implementations, the smart board 440 may be a RK3568 chip, which may have a running memory of 4G and a storage memory of 64G and equipped with Android 11.0 system. In some embodiments, the smart board 440 is configured to: obtain, via the wireless communication module 451, information on the cooking database from the cloud 460; collect user's voice via the voice recognition module 452; collect other cooking data from the user or an environment via the basic function module 453; control, via the stepper motor 454, the stirrer to achieve the target operation strategy; collect an oven cavity environment of the oven cavity 430 via the environment monitoring module 455, in w which the oven cavity environment includes an oven cavity temperature and a cooking smell of the ingredient; monitor a cooking state and a real-time temperature of the ingredient via the ingredient monitoring module 456; and display the cooking state of the ingredient to the user via the display function module 457.

In some embodiments, the wireless communication module 451 may include a two-in-one communication manner of wireless communication and bitstream communication, a 4th-generation mobile communication technology (4G) communication module, an Ultra High Frequency (UHF) radio wave card reader, and a ZigBee communication protocol. The voice recognition module 452 may include a speaker and a microphone array board to realize voice interaction with the user. The basic function module 453 may include touch buttons, a millimeter wave radar, a two-in-one unit of scanning and near-field communication, an asynchronous transceiver transmitter interface, a universal serial bus interface, a RS485 communication interface, or the like. The display function module 457 may be selected from a 7-inch touch screen or a 15.6-inch touch screen based on a user's need, enable the user to monitor the cooking state of the ingredient in real-time.

With the cooking apparatus in the present disclosure, the region cold point of the food region is collected in real time, which achieves even heating of the entire food region. In addition, the heating device is controlled to perform the targeted heating on individual ingredients based on the cooking parameters of the individual ingredients, thereby achieving an effect of getting the individual ingredients ready simultaneously with optimum cooking taste.

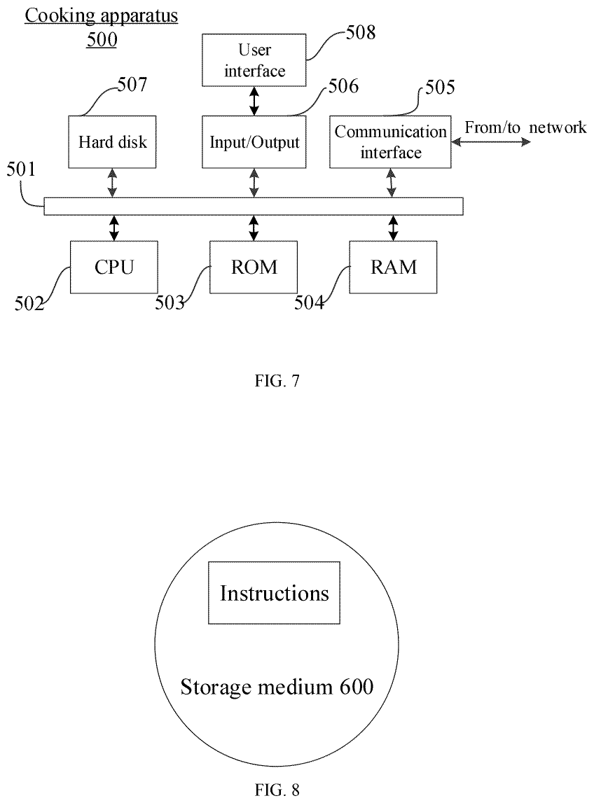

FIG. 7 is a schematic structural diagram of a cooking apparatus in still yet another aspect of the present disclosure. As illustrated in FIG. 7, in still yet another aspect of the present disclosure, a cooking apparatus 600 is further provided. The cooking apparatus 600 may include one or more processors, and one or more memories. Computer-readable codes are stored in the one or more memories. The computer-readable codes, when executed by the one or more processors, may implement the temperature control method for the cooking apparatus as described above.

The method or apparatus according to any of the embodiments of the present disclosure may also be implemented with the aid of an architecture of a cooking apparatus 500 illustrated in FIG. 7. As illustrated in FIG. 7, the cooking apparatus 500 may include a bus 501, one or more Central Processing Units (CPUs) 502, Read-Only Memory (ROM) 503, Random Access Memory (RAM) 504, a communication port 505 connected to a network, an input/output assembly 506, a hard disk 507, or the like. A storage device in the cooking apparatus 500, e.g., ROM 503 or the hard disk 507, may store the temperature control method for the cooking apparatus provided by the present disclosure. The temperature control method for the cooking apparatus may include: controlling, based on a quantity and a type of each of at least one ingredient in a food region of the cooking apparatus, a heating device of the cooking apparatus to adjust an average temperature of the food region to a first temperature, in which the first temperature is a temperature at which a region temperature difference between a region cold point and a region hot point of the food region reaches a first temperature difference threshold; determining, at a first sampling frequency, a position of the region cold point on a temperature map at each sampling time point, and controlling the heating device to heat the position of the region cold point, to adjust the average temperature of the food region from the first temperature to a second temperature, in which the temperature map is used to characterize temperature data of respective coordinate points of the cooking apparatus; and collecting a cooking parameter of each ingredient, and controlling, based on the cooking parameter, the heating device to adjust an average temperature of the ingredient from the second temperature to a target temperature. Further, the cooking apparatus 500 may also include a user interface 508. Of course, the architecture illustrated in FIG. 7 is merely exemplary. One or more components of the cooking apparatus illustrated in FIG. 7 may be omitted as desired when implementing different apparatuses.

FIG. 8 is a schematic structural diagram of a computer-readable storage medium in still yet another aspect of the present disclosure. As shown in FIG. 8, a computer-readable storage medium 600 according to an embodiment of the present disclosure is illustrated. Computer-readable instructions are stored on the computer-readable storage medium 600. When the computer-readable instructions are executed by the processor, a data synchronization method described with reference to the accompanying drawings, according to any of the embodiments of the present disclosure may be performed. The storage medium 600 includes, but is not limited to, for example, a volatile memory and/or a non-volatile memory. The volatile memory may include, for example, RAM, a cache memory, or the like. The non-volatile memory may include, for example, ROM, a hard disk, a flash memory, or the like.

In addition, according to the embodiments of the present disclosure, the processes described above with reference to the flow charts may be implemented as a computer software program. For example, the present disclosure provides a non-transitory machine-readable storage medium having machine-readable instructions stored thereon. The machine-readable instructions are executable by a processor to perform instructions corresponding to steps of the method provided by the present disclosure. For example, the instructions may include: controlling, based on a quantity and a type of each of at least one ingredient in a food region of the cooking apparatus, a heating device of the cooking apparatus to adjust an average temperature of the food region to a first temperature, in which the first temperature is a temperature at which a region temperature difference between a region cold point and a region hot point of the food region reaches a first temperature difference threshold; determining, at a first sampling frequency, a position of the region cold point on a temperature map at each sampling time point, and controlling the heating device to heat the position of the region cold point, to adjust the average temperature of the food region from the first temperature to a second temperature, in which the temperature map is used to characterize temperature data of respective coordinate points of the cooking apparatus; and collecting a cooking parameter of each of the at least one ingredient, and controlling, based on the cooking parameter, the heating device to adjust an average temperature of the ingredient from the second temperature to a target temperature. The above functions as defined in the method of the present disclosure are performed when the computer program is executed by a CPU.

The method, apparatus, and device of the present disclosure may be implemented in various ways, e.g., by software, hardware, firmware, or any combination thereof. The above sequence of the steps of the method is for illustrative purposes only. The steps of the method of the present disclosure are not limited to the sequence specifically described above, unless otherwise specifically stated. In addition, in some embodiments, the present disclosure may also be implemented as a program recorded in a recording medium. These programs include machine-readable instructions for implementing the method according to the present disclosure. Therefore, the present disclosure also includes the recording medium that stores a program for performing the method according to the present disclosure.

Further, contents of the above technical solutions according to any of the embodiments of the present disclosure that are consistent with principles of implementation of corresponding technical solutions in the related art are not described in detail to omit repeated description.

The above description is only an illustration of the embodiments of the present disclosure and the technical principles applied herein. It should be understood by those skilled in the art that the scope of the present disclosure is not limited to any technical solution obtained from a particular combination of the above technical features, and should also cover other technical solutions obtained from any combination of the above technical features or their equivalents without departing from the technical concept of the present disclosure, e.g., technical solutions obtained from interchange of the above technical features with (but not limited thereto) technical features having similar functions disclosed in the present disclosure.

What is claimed is:

1. A temperature control method for a cooking apparatus, the temperature control method comprising:
controlling, based on a quantity and a type of each of at least one ingredient in a food region of the cooking apparatus, a heating device of the cooking apparatus to adjust an average temperature of the food region to a first temperature, wherein the first temperature is a temperature at which a region temperature difference between a region cold point and a region hot point of the food region reaches a first temperature difference threshold;
determining, at a first sampling frequency, a position of the region cold point on a temperature map at each sampling time point, and controlling the heating device to heat the position of the region cold point to adjust the average temperature of the food region from the first temperature to a second temperature, wherein the temperature map is used to characterize temperature data of respective coordinate points of the cooking apparatus; and
collecting a cooking parameter of each of the at least one ingredient, and controlling, based on the cooking parameter, the heating device to adjust an average temperature of the ingredient from the second temperature to a target temperature.

2. The temperature control method for the cooking apparatus according to claim 1, wherein said collecting the cooking parameter of each of the at least one ingredient, and controlling, based on the cooking parameter, the heating device to adjust the average temperature of the ingredient from the second temperature to the target temperature comprises:
collecting the cooking parameter of each of the at least one ingredient, wherein the cooking parameter comprises an attribute, a target temperature rise value, and the target temperature of the ingredient; and
controlling, when the attribute of the ingredient is homogenized food, the heating device to perform a scan heating on the ingredient based on the target temperature rise value and the target temperature of the ingredient, to adjust the average temperature of the ingredient from the second temperature to the target temperature.

3. The temperature control method for the cooking apparatus according to claim 1, wherein said collecting the cooking parameter of each of the at least one ingredient, and controlling, based on the cooking parameter, the heating device to adjust the average temperature of each of the at least one ingredient from the second temperature to the target temperature comprises:
collecting the cooking parameter of each of the at least one ingredient, wherein the cooking parameter comprises an attribute, a target temperature rise value, and the target temperature of the ingredient;
determining, when the attribute of the ingredient is non-homogenized food, at a second sampling frequency, a position of an ingredient cold point of the ingredient on the temperature map at each sampling time point; and
controlling, based on the target temperature rise value and the target temperature of the ingredient, the heating device to heat the position of the ingredient cold point, to adjust the average temperature of the ingredient from the second temperature to the target temperature.

4. The temperature control method for the cooking apparatus according to claim 1, wherein said collecting the cooking parameter of each of the at least one ingredient, and controlling, based on the cooking parameter, the heating device to adjust the average temperature of the ingredient from the second temperature to the target temperature comprises:
collecting the cooking parameter of each of the at least one ingredient, wherein the cooking parameter comprises an attribute, a target temperature rise value, and the target temperature of the ingredient;
determining, when the attribute of the ingredient is semi-homogenized food, based on the temperature map, a position of a homogenized portion of the ingredient and a position of a non-homogenized portion of the ingredient, respectively, wherein the ingredient comprises the homogenized portion having an attribute of homogenized food and the non-homogenized portion having an attribute of non-homogenized food;
controlling, based on the cooking parameter, the heating device to perform a scan heating on the homogenized portion, to adjust an average temperature of the homogenized portion from the second temperature to the target temperature;
determining, at a second sampling frequency, a position of an ingredient cold point of the non-homogenized portion on the temperature map at each sampling time point; and
controlling, based on the cooking parameter, the heating device to heat the position of the ingredient cold point, to adjust an average temperature of the non-homogenized portion from the second temperature to the target temperature.

5. The temperature control method for the cooking apparatus according to claim 1, wherein said collecting the cooking parameter of each of the at least one ingredient, and controlling, based on the cooking parameter, the heating device to adjust the average temperature of the ingredient from the second temperature to the target temperature comprises:
collecting the cooking parameter of each of the at least one ingredient, wherein the cooking parameter comprises an attribute, a target temperature rise value, and the target temperature of the ingredient;
collecting, when the attribute of the ingredient is semi-homogenized food, an ingredient cold point and an ingredient hot point on the temperature map at a second sampling frequency, wherein the attribute of the ingredient is variable between homogenized food and non-homogenized food;
controlling, when an ingredient temperature difference between the ingredient cold point and the ingredient hot point is smaller than or equal to a second temperature difference threshold, the heating device to perform a scan heating on the ingredient based on the cooking parameter;
determining, when the ingredient temperature difference between the ingredient cold point and the ingredient hot point is greater than the second temperature difference threshold, a position of the ingredient cold point; and
controlling, based on the cooking parameter, the heating device to heat the position of the ingredient cold point, to adjust the average temperature of the ingredient from the second temperature to the target temperature.

6. The temperature control method for the cooking apparatus according to claim 1, wherein said controlling, based on the cooking parameter, the heating device to adjust the average temperature of the ingredient from the second temperature to the target temperature comprises:
controlling, based on the cooking parameter, a magnetron of the heating device to emit electromagnetic waves at a target power;
controlling, based on the cooking parameter, a stirrer of the heating device to refract the electromagnetic waves from the magnetron in accordance with a target operation strategy; and
adjusting, through cooperation between the magnetron and the stirrer, the average temperature of the ingredient from the second temperature to the target temperature.

7. The temperature control method for the cooking apparatus according to claim 6, wherein the target operation strategy of the stirrer comprises a constant-speed stirring strategy and a fixed-point heating strategy, the fixed-point heating strategy being to control the stirrer to refract the electromagnetic waves from the magnetron to the position of the region cold point or a position of an ingredient cold point, enabling the region cold point or the ingredient cold point to receive a large amount of the electromagnetic waves.

8. The temperature control method for the cooking apparatus according to claim 2, wherein said collecting the cooking parameter of each of the at least one ingredient comprises:
analyzing inputted control data to obtain the cooking parameter, wherein the inputted control data comprises a heating level, time, and the type of the ingredient; or
collecting the type of the ingredient, and obtaining the cooking parameter of the ingredient from a cooking database.

9. The temperature control method for the cooking apparatus according to claim 8, further comprising, prior to said collecting the type of the ingredient, and obtaining the cooking parameter of the ingredient from the cooking database:
obtaining, from a cloud and a user end, cooking parameters corresponding to types of a plurality of ingredients; and
integrating the types of the plurality of ingredients and the cooking parameters corresponding to the types of the plurality of ingredients to obtain the cooking database.

10. The temperature control method for the cooking apparatus according to claim 9, further comprising, subsequent to said integrating the types of the plurality of ingredients and the cooking parameters corresponding to the types of the plurality of ingredients to obtain the cooking database:
updating the cooking database at a predetermined update cycle.

11. The temperature control method for the cooking apparatus according to claim 1, further comprising, prior to said controlling, based on the quantity and the type of each of the at least one ingredient in the food region of the cooking apparatus, the heating device of the cooking apparatus to adjust the average temperature of the food region to the first temperature:
identifying the type and the quantity of the ingredient.

12. The temperature control method for the cooking apparatus according to claim 11, wherein said identifying the type and the quantity of the ingredient comprises:
scanning, by a Quick Response code scanning device, a Quick Response code identifier for characterizing ingredient information, to obtain the type and the quantity of the ingredient;
capturing a picture of the ingredient by an external camera, and analyzing the picture of the ingredient by an ingredient recognition model, to obtain the type and the quantity of the ingredient; or
collecting control data containing the type and the quantity of the ingredient from a control panel.

13. The temperature control method for the cooking apparatus according to claim 12, further comprising, subsequent to said identifying the type and the quantity of the ingredient:
collecting temperature data of each pixel of the cooking apparatus by an infrared array sensor; and
determining the food region of the cooking apparatus based on the temperature data.

14. The temperature control method for the cooking apparatus according to claim 13, further comprising, prior to said controlling, based on the quantity and the type of each of the at least one ingredient in the food region of the cooking apparatus, the heating device of the cooking apparatus to adjust the average temperature of the food region to the first temperature:
collecting an initial temperature of each pixel in the food region;
selecting a plurality of pixels each having the initial temperature lower than a defrosting temperature, and determining positions of the plurality of pixels as a region to be defrosted;
controlling the heating device of the cooking apparatus to heat the region to be defrosted, to increase an average temperature of the region to be defrosted to the defrosting temperature; and
controlling, in response to detecting that the average temperature of the region to be defrosted reaches the defrosting temperature, the heating device of the cooking apparatus based on the quantity and the type of each of the at least one ingredient in the food region of the cooking apparatus to adjust the average temperature of the food region to the first temperature.

15. The temperature control method for the cooking apparatus according to claim 14, further comprising, prior to said controlling, based on the quantity and the type of each of the at least one ingredient in the food region of the cooking apparatus, the heating device of the cooking apparatus to adjust the average temperature of the food region to the first temperature:
detecting dimensional data of the cooking apparatus, and establishing an oven cavity coordinate system based on the dimensional data, wherein the oven cavity coordinate system is used to characterize a three-dimensional position of each pixel of the cooking apparatus in a form of coordinate points;
collecting the temperature data of each pixel of the cooking apparatus by the infrared array sensor; and
mapping the temperature data of each pixel of the cooking apparatus to the oven cavity coordinate system to generate the temperature map, wherein the temperature map is used to characterize temperature data of each coordinate point of the cooking apparatus.

16. The temperature control method for the cooking apparatus according to claim 15, further comprising, subsequent to said mapping the temperature data of each pixel of the cooking apparatus to the oven cavity coordinate system to generate the temperature map:
collecting the temperature data of each coordinate point of the cooking apparatus in real time to update the temperature map in real time.

17. The temperature control method for the cooking apparatus according to claim 1, further comprising:
activating a cooking state monitoring device to collect a cooking state of the ingredient in real time; and
feeding the cooking state back to a user end.

18. A temperature control system for a cooking apparatus, the temperature control system comprising:
a first temperature heating module configured to control, based on a quantity and a type of each of at least one ingredient in a food region of the cooking apparatus, a heating device of the cooking apparatus to adjust an average temperature of the food region to a first temperature, the first temperature being a temperature at which a region temperature difference between a region cold point and a region hot point of the food region reaches a first temperature difference threshold;
a temperature rise heating module configured to determine, at a first sampling frequency, a position of the region cold point on a temperature map at each sampling time point, and to control the heating device to heat the position of the region cold point, to adjust the average temperature of the food region from the first temperature to a second temperature, wherein the temperature map is used to characterize temperature data of respective coordinate points of the cooking apparatus; and
a target temperature heating module configured to collect a cooking parameter of each of the at least one ingredient, and to control, based on the cooking parameter, the heating device to adjust an average temperature of the ingredient from the second temperature to a target temperature.

19. A cooking apparatus, comprising:
a memory;
a processor; and
a computer program stored in the memory and executable on the processor,
wherein the computer program, when executed by the processor, implements a temperature control method for a cooking apparatus, the temperature control method comprising:
controlling, based on a quantity and a type of each of at least one ingredient in a food region of the cooking apparatus, a heating device of the cooking apparatus to adjust an average temperature of the food region to a first temperature, wherein the first temperature is a temperature at which a region temperature difference between a region cold point and a region hot point of the food region reaches a first temperature difference threshold;
determining, at a first sampling frequency, a position of the region cold point on a temperature map at each sampling time point, and controlling the heating device to heat the position of the region cold point to adjust the average temperature of the food region from the first temperature to a second temperature, wherein the temperature map is used to characterize temperature data of respective coordinate points of the cooking apparatus; and
collecting a cooking parameter of each of the at least one ingredient, and controlling, based on the cooking parameter, the heating device to adjust an average temperature of the ingredient from the second temperature to a target temperature.

20. A non-transitory storage medium, having a computer program stored thereon, wherein the computer program, when executed by a processor, implements the temperature control method for the cooking apparatus according to claim 1.
